(19) United States
(12) Patent Application Publication
(10) Pub. No.: US 2018/0229376 A1
(43) Pub. Date: Aug. 16, 2018

(54) DEVICE FOR AUTOMATED HANDLING OF BEVEL GEAR COMPONENTS

(71) Applicant: Klingelnberg AG, Zurich (CH)

(72) Inventors: David Augustin, Remscheid (DE); Christian Brieden, Huckeswagen (DE); Jürgen Gsell, Remscheid (DE); Bernd Von der Mark, Radevormwald (DE)

(21) Appl. No.: 15/898,382

(22) Filed: Feb. 16, 2018

(30) Foreign Application Priority Data
Feb. 16, 2017 (DE) 102017103129.4

(51) Int. Cl. B25J 15/00; B25J 11/00

(52) U.S. Cl. CPC B25J 15/0028; B23F 23/06; B25J 11/0055; B25J 15/0033

(57) ABSTRACT

A device having at least two grippers (102) for the form-fitting gripping of a bevel gear (1) having a cone face, a heel region, and an axis of rotation (RA). The at least two grippers (102) can be infed radially in relation to the axis of rotation (RA), and each of the grippers (102) has at least one inner region (104) for interacting with the cone face, and a counter holder (103) for interacting with the heel region. Each gripper (102) can have a holder (101) having a changeable angle of attack on an inner region (104) of the holder, and the holder (101) can be movably mounted on the gripper (102) so that it adapts its effective angle of attack in relation to the inclination of the cone face of the bevel gear (1) during radial infeed in the direction of the bevel gear (1).

### CROSS REFERENCE TO RELATED APPLICATIONS

This application claims priority under 35 U.S.C. §§ 119(a)-(d) to German patent application no. DE 10 2017 103 129.4 filed Feb. 16, 2017, which is hereby expressly incorporated by reference as part of the present disclosure.

### FIELD OF THE INVENTION

The present disclosure generally relates to devices for automated handling of bevel gear components.

### BACKGROUND

Robots and other handling devices are increasingly being used to change workpieces and/or tools in an automated manufacturing environment. There are corresponding solutions for the mass production of gearwheels, which enable a gearwheel workpiece to be introduced into a gear cutting machine or a finished machined gearwheel workpiece to be removed from the machine, to then transfer it to a measuring center or place it in a storage container.

FIG. 1A shows the schematic side view of a bevel gear pinion 1, wherein elements and terms are defined on the basis of this side view, which are used in the scope of the present document. This is a bevel gear pinion 1 having curved flank longitudinal line. The invention may also be applied to other bevel gear pinions 1 and to bevel gears in general. The bevel gear pinion 1 has two cone faces in the example shown. The intersection lines of the rear cone face with the plane of the drawing are shown by the auxiliary lines 1.5. The intersection lines of the head cone face with the plane of the drawing are shown by the auxiliary lines 1.6. The teeth of the bevel gear pinion 1 extend along the head cone face. The rear end face (sometimes also called the installation face) is identified by the reference sign 1.4. The cone face shown in gray, which represents a part of the rear cone face, is referred to as the rear face or lateral face 1.3. In combination, the rear face 1.3 and the rear end face 1.4 are called the heel region 1.2 here.

FIG. 1B shows a side view of a further bevel gear pinion 1, to be able to show the head cone angle δₐ on the basis of this figure. The head cone angle δₐ is defined here in relation to the axis of rotation RA.

A bevel gear 1 can comprise, as shown in FIG. 1A, a short stub shaft 1.7 or a shaft 1.8, as shown in FIG. 1B and FIG. 2.

To be able to remove a bevel gear 1 in a manufacturing environment—for example, after processing by the cutting machining—from a machine tool, gripping devices are used, as discussed above.

FIG. 2A shows three grippers 2 of a gripping device of the prior art by way of example. The mentioned grippers 2 are especially designed for formfitting gripping of the bevel gear 1. The grippers 2 can be infed radially in relation to the axis of rotation RA of the bevel gear 1. Each of the grippers 2 comprises at least one inner face 4 to interact with the cone face 1.1 of the bevel gear 1 and a counter holder 3 to interact with the heel region 1.2.

FIG. 2B shows the bevel gear pinion 1 of FIG. 2A in a schematic side view, wherein one of the grippers 2 is shown in section. In this sectional view of the grippers 2, the inner face 4 may be shown better than in FIG. 2A. It can also be seen in FIG. 2B that the counter holder 3 presses against the heel region 1.2.

To enable reliable, form-fitting gripping of various bevel gears 1, grippers 2 have heretofore been used which are especially adapted to the shape and size of the bevel gear 1. If ten different bevel gears are produced in a manufacturing environment, for example, a corresponding number of different grippers has heretofore also had to be provided.

On the one hand, additional cost and space expenditure thus results. Further, the gripper change consumes time.

### SUMMARY OF THE INVENTION

It is an object to provide a device for gripping bevel gears which is universal.

In one aspect, a device is provided, comprising at least two grippers for the form-fitting gripping of a bevel gear having a cone face, a heel region, and an axis of rotation.

In at least some embodiments the grippers can be infed radially in relation to the axis of rotation of the bevel gear and each of the grippers comprises at least one inner region for interacting with the cone face and a counter holder for interacting with the heel region.

In at least some embodiments, the device has a holder having a changeable angle of attack located in or on the inner region of each gripper. This holder is movably mounted such that it adapts its angle of attack in relation to the inclination of the cone face of the bevel gear upon the radial infeed in the direction of the bevel gear.

In at least some embodiments, the grippers have an automatically adapting angle of attack in the region of the inner face.

In at least some embodiments, the holder is a rocker, which has a pivot axis. The holder is movably mounted about this pivot axis, so that the holder can execute rocking movements.

In another aspect, grippers operate in a form-fitting manner, such that the grippers do not cause damage to the bevel gear or leave gripping tracks, for example, in the form of grooves.

In another aspect, depending on the configuration and arrangement of the holder on the gripper, an angle adjustment range may result from the pivoting ability of the holder in relation to the gripper. The angle adjustment range can be in the range of ±20°, depending on the embodiment of the gripper.

Some embodiments may have an angle adjustment range of at least ±10°.

Since bevel gears not only have different head cone angles, but rather frequently also have different heel regions, some embodiments can have an adjustable counter holder instead of a fixed counter holder. An adjustable counter holder in the meaning of this disclosure is a counter holder which is movably mounted on the gripper and/or which comprises at least one movably mounted ball or pressure element.

In some embodiments, the counter holder is designed so that it functions independently of the location of the tooth gaps of the bevel gear. For this purpose, for example, instead of a fixed cantilever, two balls or pressure elements can be attached to the cantilever. The effective contact point of the counter holder on the heel region thus lies at the same height—independently thereof. To enable this, the spacing of the balls or pressure elements is such that at least one ball or one pressure element does not strike on a gap in the heel region.

In some embodiments the gripper can be designed as replaceable, to perform an adaptability to the respective bevel gear geometry.

In some embodiments, the gripper can be equipped with a replaceable holder, to perform an adaptability to the respective bevel gear geometry.

In some embodiments, the counter holder and/or the balls or pressure elements can be replaceable, to perform an adaptability to the respective bevel gear geometry.

In another aspect, the device can be equipped with a fixed or an adjustable counter holder.

In accordance with one aspect, a device includes two or more grippers configured to form-fittingly grip a bevel gear that has a cone face, a heel region, and an axis of rotation. The grippers are configured to be infed radially relative to the axis of rotation, and each gripper has at least one inner region configured to interact with the cone face, a counter holder for interacting with the heel region, and a holder located at the inner region that has a changeable angle of attack. The holder may be movably mounted on the gripper so that its angle of attack can change in relation to an inclination of the cone face of the bevel gear during infeeding of the grippers, e.g., so as to match the inclination. The holder may be configured as a rocker, and can be pivotably mounted on the gripper about a pivot axis. The holder and the counter holder may be configured as a rocker, mounted pivotably on the gripper about a pivot axis. The holder may be movable in coordination with the counter holder. The counter holder may be fixedly connected to its gripper. The holder may be mounted in a receptacle opening of its gripper. The holder can define a lateral surface that exerts a mechanical interaction with the cone face of the bevel gear. The counter holder can define a cantilever or plate fixedly connected to the gripper. The counter holder can alternatively define a cantilever or plate movably connected to the gripper. In at least some embodiments, the cantilever or plate is movable or rotatable about a pivot axis. In at least some embodiments, the counter holder includes a ball or a pressure element. In at least some embodiments, the ball or the pressure element is movably mounted on the counter holder. The grippers can include a base movably mounted in a linear guide along which the gripper moves linearly during radially infeeding (or outfeeding).

In at least some embodiments, the lateral surface defines a planar surface that, after radial infeeding, is tangential to a circumferential circle defined by the cone face. In other embodiments, the lateral surface is curved so as to engage against the circumferential circle of the cone face after radial infeeding.

In accordance with a another aspect, a handling device, e.g., for use in or on a bevel gear cutting machine, may include any of the above-mentioned devices, and further include a drive configured to radially infeed the at least two grippers relative to the axis of rotation of the bevel gear.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this Summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features of the disclosure will become apparent from the following detailed description, which are to be understood not to be limiting and which will be described in greater detail hereafter with reference to the drawings, wherein:

FIG. 1A shows a side view of a previously-known bevel gear pinion;

FIG. 1B shows a schematic side view of a further previously-known bevel gear pinion;

FIG. 2A shows a previously-known device having three grippers during the form-fitting gripping of a bevel gear;

FIG. 2B shows a side view of the bevel gear of FIG. 2A having a gripper in sectional view;

FIG. 3A shows a side view of the bevel gear of FIG. 2A and a schematic sectional view of a gripper before radial infeed;

FIG. 3B shows the gripper of FIG. 3A after radial infeed;

FIG. 4A shows a schematic sectional view of a further gripper, which comprises a counter holder having a fixed ball or pressure element;

FIG. 4B shows a schematic sectional view of a further gripper, which comprises a counter holder having a movable ball or pressure element;

FIG. 5A shows a perspective view of a further gripper of a device after radial infeed toward a bevel gear pinion;

FIG. 5B shows the gripper of FIG. 5A in an enlarged side view (the bevel gear pinion is not shown);

FIG. 5C shows the gripper of FIG. 5A in an enlarged perspective view (the bevel gear pinion is not shown);

FIG. 5D shows a further gripper, constructed similarly to the gripper of FIGS. 5A, 5B and 5C, wherein the gripper body comprises an upper plate having a ball or pressure element;

FIG. 5E shows the upper region of a further gripper, which is constructed similarly to the gripper of FIG. 5D, wherein an upper plate is pivotably mounted;

FIG. 5F shows a further gripper, which comprises a combined holder and counter-holder, wherein the combined holder and counter-holder are pivotably mounted on a gripper body;

FIG. 6A shows a perspective view of a further gripper of a device, wherein the bevel gear pinion was blanked out and the holder is located in an upper pivot position;

FIG. 6B shows the gripper of FIG. 6A in an enlarged perspective view, wherein the holder is located in a steeper pivot position;

FIG. 7A shows an enlarged, schematic perspective view of a holder (the through-hole for fastening the pivot axis is not shown);

FIG. 7B shows an enlarged, schematic perspective view of a further holder (the through-hole for fastening the pivot axis is not shown);

FIG. 8A shows a perspective view of a device that encloses a bevel gear pinion in a form-fitting manner using three grippers;

FIG. 8B shows a perspective view of a handling device that comprises two devices of FIG. 8A as the add-on part of a robot;

FIG. 9 shows a perspective view of the two grippers of a device that enclose a bevel gear pinion in a form-fitting manner.

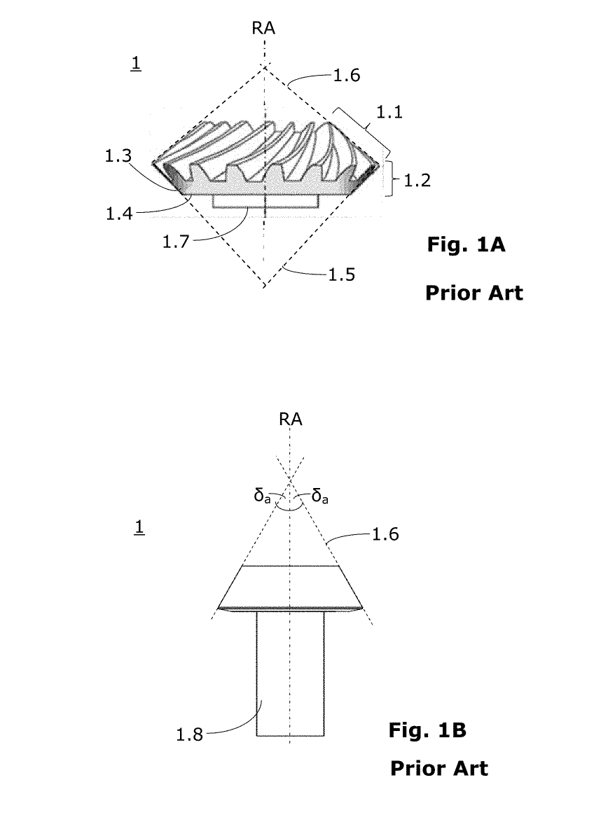

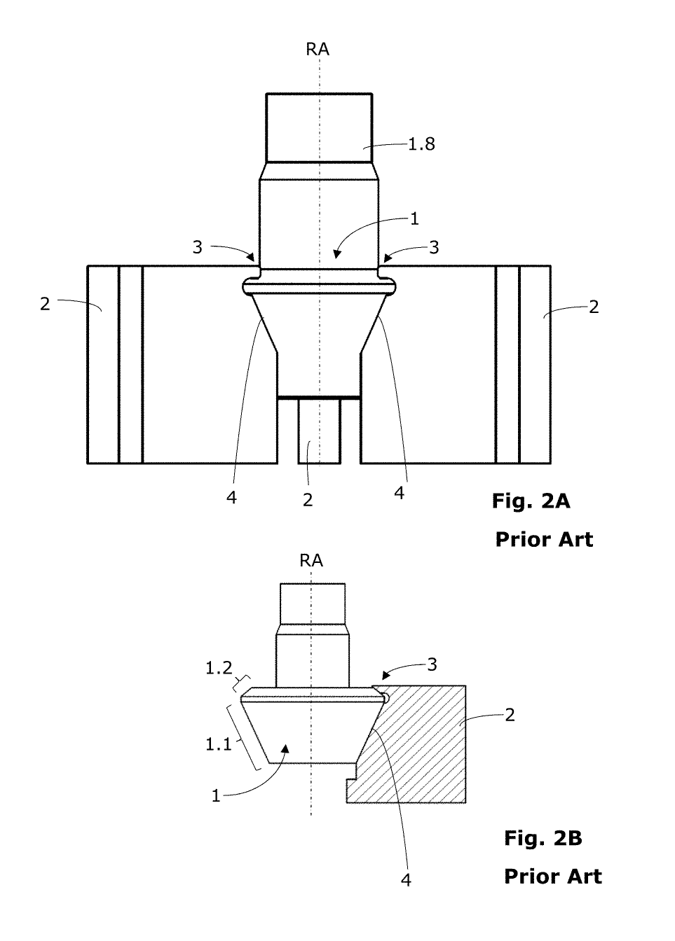

### DETAILED DESCRIPTION

Terms are used in conjunction with the present invention which are also used in relevant publications and patents. However, it is to be noted that the use of these terms is only to serve for better understanding. The inventive concepts and the scope of protection of the patent claims are not to be restricted in the interpretation by the specific selection of the terms. The invention may be readily transferred to other term systems and/or technical fields. The terms are to be applied accordingly in other technical fields.

This relates to the gripping and handling of bevel gears 1. Bevel gear pinions 1 are shown in each of the figures, wherein the invention may also be applied to other bevel gears.

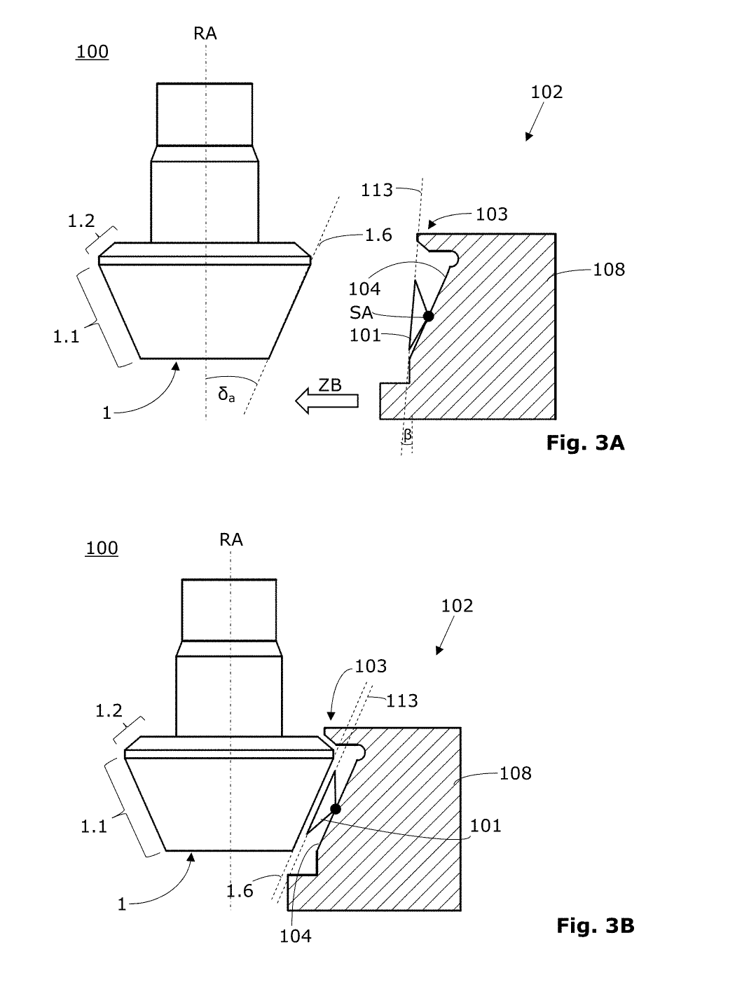

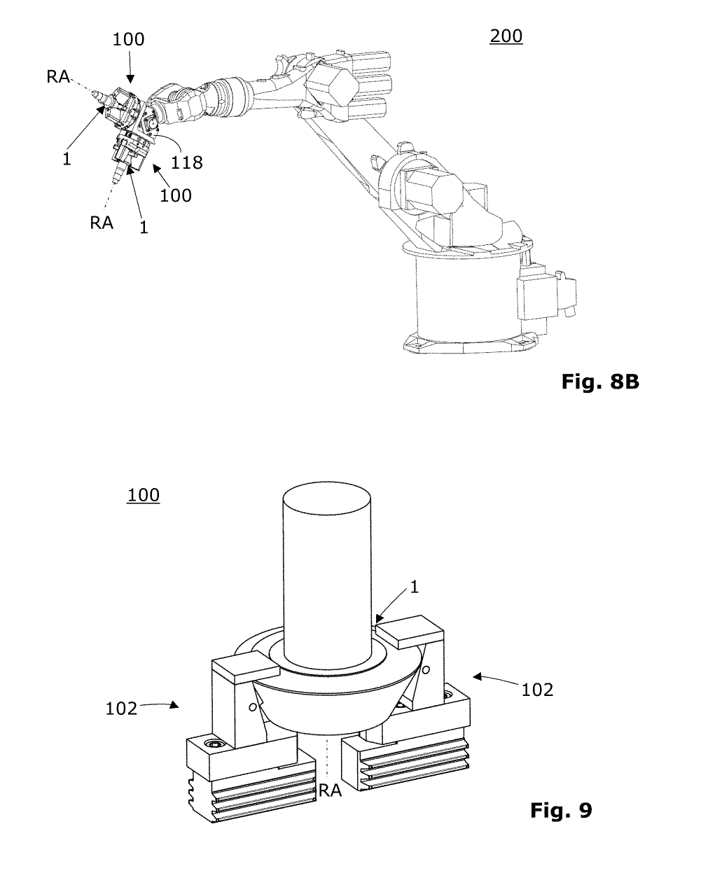

FIGS. 3A and 3B relate to a device 100 (which can be part of a handling device 200, for example, as shown in FIG. 8B), which comprises at least two grippers 102 for the form-fitting gripping of a bevel gear 1. The bevel gear 1 has, as described at the outset, a cone face 1.1, a heel region 1.2, and a central axis of rotation RA.

The grippers 102 of the device 100 can be infed radially in relation to the axis of rotation RA of the bevel gear 1. The radial infeed movement is shown in FIG. 3A by the block arrow ZB.

In FIGS. 3A and 3B each of the grippers 102 comprises at least one inner region 104 for indirectly interacting with the cone face 1.1 and a counter holder 103 for interacting with the heel region 1.2.

In at least some embodiments, the device 100 comprises a holder 101 having a changeable angle of attack β in or on the inner region 104. The holder 101 is movably mounted so that during the radial infeed in the direction of the bevel gear 1, it adapts its angle of attack β in relation to the inclination (defined by the head cone angle δₐ) of the cone face 1.1 of the bevel gear 1.

FIG. 3A shows a gripper 102 in a starting position. The holder 101 is located in a starting position that is schematically shown by a triangular rocker having horizontal pivot axis SA. The holder 101 is seated on an inner face in the inner region 104.

The inner region 104 may be defined as the region which faces in the direction of the bevel gear 1 to be gripped.

Two dashed auxiliary lines 1.6 and 113 are shown in FIG. 3A, to show both the head cone angle δₐ and also the angle of attack β. It can be seen that in this starting position, the two auxiliary lines 1.6 and 113 have a different slope, i.e., δₐ≠β.

If the gripper 102 is infed radially in the direction of the axis of rotation RA, as indicated by the block arrow ZB, a mechanical interaction thus occurs between the holder 101 and the cone face 1.1 of the bevel gear 1.

If the angle of attack β of the holder 101 corresponds to the head cone angle δₐ in the starting position, the holder 101 may need not execute a rocking or pivot movement about the pivot axis SA during the infeed. The holder 101 may thus remain in the starting position in that case. Together with the counter holder 103, the holder 101 of the gripper 102 would hold the bevel gear 1, when at least one second gripper 102 is infed diametrically opposite (see e.g., FIG. 9).

However, as already mentioned, an example is shown in FIG. 3A in which the angle of attack β and the head cone angle δₐ differ. The head cone angle δₐ is greater in FIG. 3A than the angle of attack β of the holder 101 in the starting position. When a mechanical interaction occurs between the cone face 1.1 of the bevel gear 1 and the holder 101 during the infeed, the holder 101 executes a rocking or pivot movement clockwise about the pivot axis SA.

The final position of the holder 101 as shown in FIG. 3B then results automatically, i.e., without external influence. The angle of attack β of the holder 101 automatically adapts to the head cone angle δₐ and the two auxiliary lines 1.6 and 113 extend parallel to one another, i.e., δₐ=β.

Depending on the configuration and arrangement of the holder 101 on the gripper 102, a maximum angle adjustment range results because of the pivoting ability of the holder 101 in relation to the gripper 102.

The angle adjustment range can be, depending on the design of the gripper 102, in the range of ±20°.

In the example shown in FIGS. 3A and 3B, the effective angle adjustment range is ±15°.

A device 100 of the invention, which is equipped with two or three of the grippers 102 of FIGS. 3A and 3B can grip bevel gears 1 having head cone angles δₐ in the range of approximately 8° to approximately 38°. The bevel gear 1 of FIGS. 3A, and 3B has a head cone angle δₐ=28°.

The effective angle adjustment range is dependent on the arrangement of the pivot axis SA, the shaping of the holder 101, and the shaping of the inner region 104.

It can be seen in FIG. 3A, for example, that the holder 101 cannot be rotated further counterclockwise because of the shaping of the inner face of the inner region 104. The inner face is used as a lower stop for the holder 101. The angle adjustment range downward is restricted to the above-mentioned 8° by this lower stop. If the holder 101 is rotated clockwise about the pivot axis SA, an upper stop thus results. The angle adjustment range is restricted upward to the above-mentioned 38° by this upper stop.

In at least some embodiments the holder 101 can be elastically mounted to avoid hard impacts during the interaction with the cone face 1.1. For this purpose, a torsion spring can be seated in the region of the pivot axis SA, or compression springs can be arranged in the region of the inner face.

Since certain devices 100 are discussed herein which grip in a form-fitting manner, the holder 101 of each gripper 102 can also be provided in at least some embodiments with a layer, coating, or an element which is elastically yielding. Damage to the bevel gear 1 can thus be avoided. It is thus also possible to prevent the holders 101 of the device 100 from being damaged if chips enter the interaction region or if burrs, which can be very sharp, have formed, for example, on the bevel gear 1.

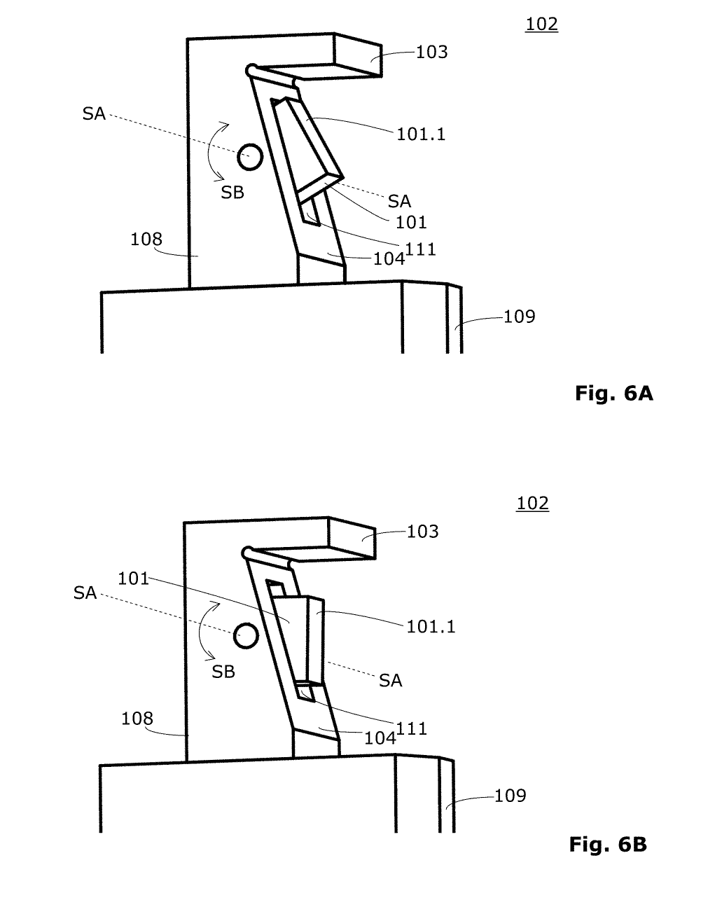

Since bevel gears 1 not only can have different head cone angles 6, but rather frequently also have different heel regions 1.2, the device 100 may have an adjustable counter holder 103 instead of a fixed counter holder 103 (see e.g., FIGS. 3A, 3B, 6A, and 6B).

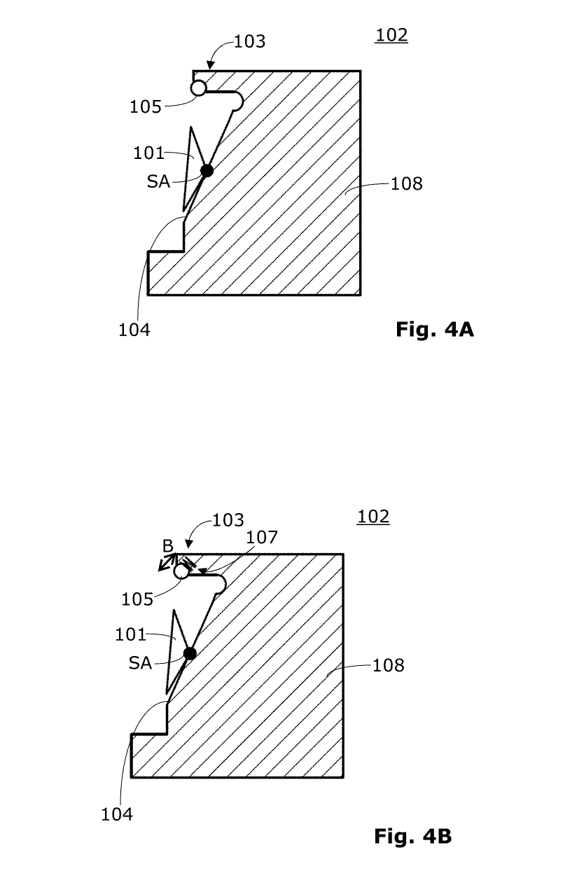

FIG. 4B shows an embodiment with a first adjustable counter holder 103. The counter holder 103 comprises a ball or another pressure element 105, which is spring-loaded, for example. A borehole or bushing is provided in a gripper body 108 of the gripper 102 in FIG. 4B, in which a spring 107 or an elastic buffer is seated. It is indicated by the double arrow B that the ball or the pressure element 105 can execute a movement.

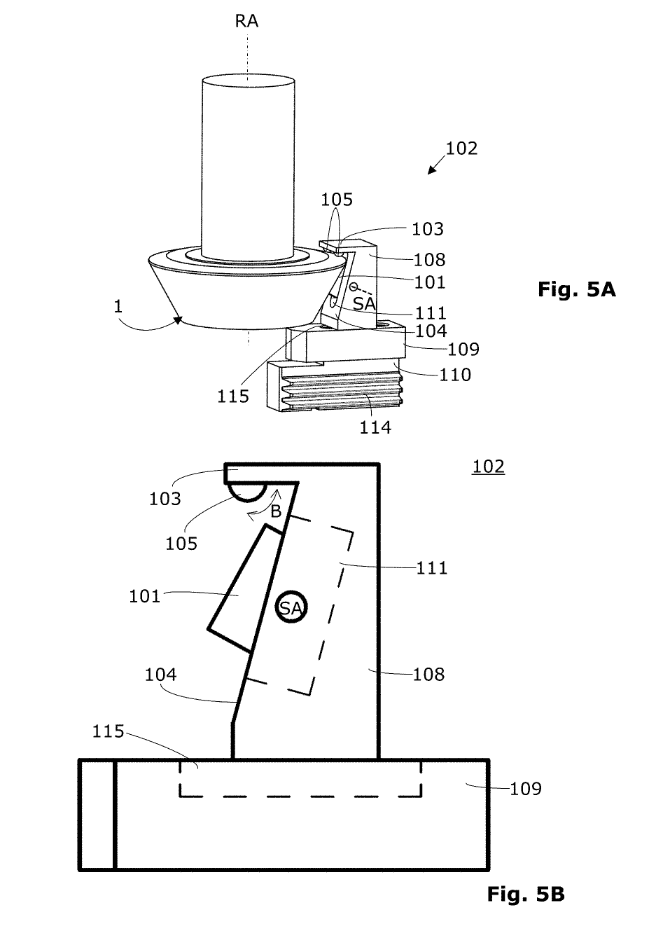

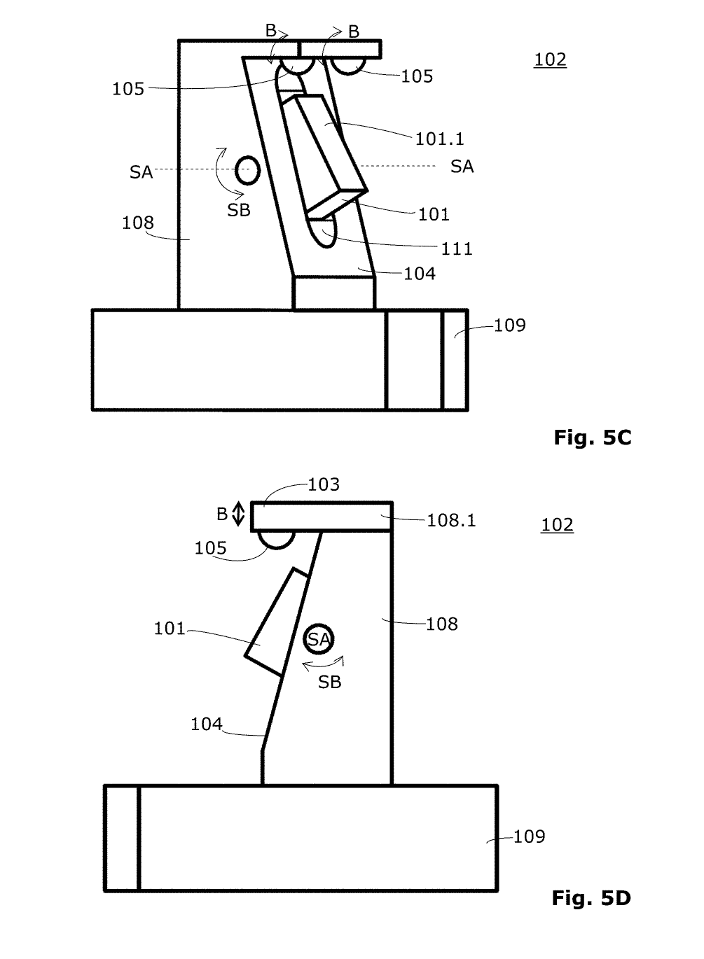

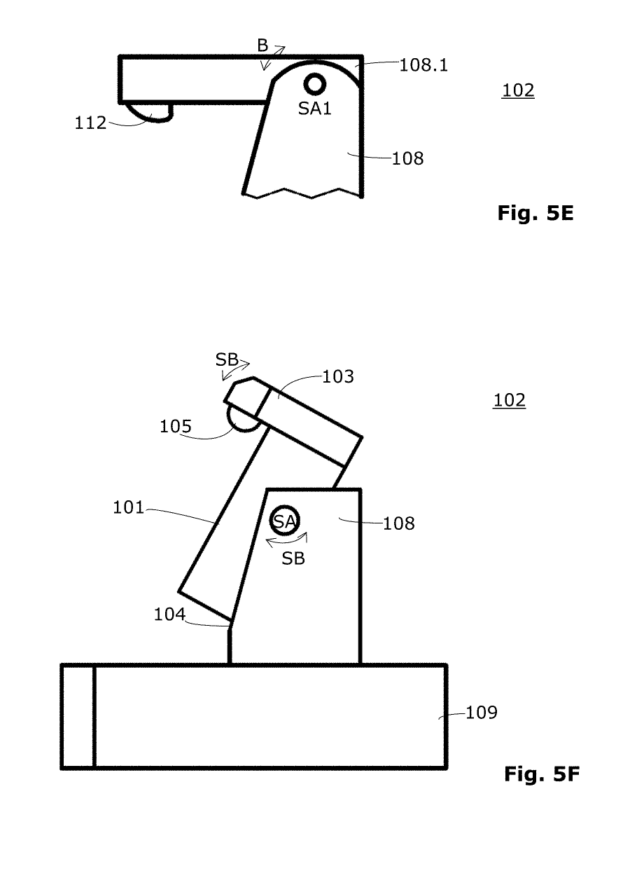

FIGS. 5A, 5B and 5C show a further embodiment.

These figures show a bevel gear pinion 1 in combination with a gripper 102, wherein the gripper 102 has been infed toward the bevel gear pinion 1. From bottom to top, the gripper 102 comprises the following:
a base 110 having horizontally extending guide ribs 114;
a receptacle 109, which can be part of the base 110, or which can be connected (for example, screwed together or attached) to the base 110;
an oblong hole 115 can be provided in the receptacle 109, to be able to receive and fasten a gripper body 108;
a gripper body 108, which may be seated in the oblong hole 115 and/or connected or attached therein;
an inner region 104, which comprises a receptacle opening 111 for receiving the holder 101 on the gripper body 108;
in the embodiment shown in FIG. 5A, the pivot axis SA can be horizontally arranged on the gripper body so that it penetrates the gripper body 108, the receptacle opening 111, and the holder 101;
a counter holder 103, which may be, as in the illustrated embodiment, fixedly connected to the gripper body 108 and form a type of cantilever, which is oriented radially in the direction of the axis of rotation RA;
two balls or pressure elements 105 arranged on the counter holder 103.

The balls or pressure elements 105 can be connected to the gripper body 108 so that they can rotate, or to the counter holder 103 so that they are linearly movable, as shown in FIG. 4B by the double arrow B.

If the grippers 102 of the invention comprise a base 110 having horizontally extending guide ribs 114, complementary guide structures can thus be provided on a main body, to guide the grippers 102 linearly. A drive (for example, a motor having gearing elements, or a drive operated using compressed air) can also be provided on the main body, to be able to radially infeed the two or three grippers 102.

FIGS. 5B and 5C show an enlarged side view and a perspective view, respectively, of the upper part of the gripper 102 of FIG. 5A. From bottom to top, the illustrated gripper 102 includes the following:
the receptacle 109 having an oblong hole 115 indicated by dashed lines;
the gripper body 108 having an upper cantilever, which may be used as the counter holder 103;
the gripper body 108 having an inclined inner region 104;
the gripper body 108 having a receptacle opening 111, indicated by dashed lines, including holder 101;
the pivot axis SA, which is perpendicular to the plane of the drawing, wherein the pivot movement of the holder 101 is indicated by the double arrow SB;
The balls 105 can be fastened in the counter holder 103 so that they can rotate. This optional rotation is indicated by double arrows B.

An enlarged side view of a further embodiment of a gripper 102 is shown in FIG. 5D, which is constructed similarly to the gripper 102 of FIGS. 5A, 5B and 5C. In contrast to the embodiments of FIGS. 5A, 5B and 5C, the gripper 102 of FIG. 5D comprises a plate or an attachment 108.1, which may be used as the cantilever of the counter holder 103. Moreover, in some embodiments, the ball 105 may be movably mounted on the counter holder 103 so that it can execute an optional linear movement, indicated by the double arrow B.

The ball 105 may be spring-loaded to allow exertion of a restoring force in the direction of the heel region 1.2 of the bevel gear 1. The ball 105 can also be fixedly mounted, or it can mounted so that it is linearly movable (see FIG. 5D) or rotationally movable (see FIGS. 5B and 5C) without spring action.

A further embodiment shown in FIG. 5E shows an enlarged side view of the uppermost part of a gripper 102, which is constructed similarly to the gripper 102 of FIG. 5D. In contrast to the embodiment of FIG. 5D, the gripper 102 of FIG. 5E comprises a plate or an attachment 108.1, which may be used as the movable cantilever of the counter holder 103. Accordingly, a further pivot axis SA1 can be provided, on the gripper body 108. The pivot axis SA1 in the illustrated embodiment is perpendicular to the plane of the drawing. It can enable a pivot movement B of the cantilever of the counter holder 103. Since in this embodiment the cantilever itself can move, a damper 112 which may be elastic, can be fixedly connected to the cantilever, as shown in FIG. 5E.

A further embodiment is shown in FIG. 5F, which is a side view of a gripper 102. The gripper 102 comprises a combined holder/counter holder 101/103, wherein this combined holder/counter holder 101/103 is pivotably mounted on a gripper body 108. A pivot axis SA is also provided, on which to mount the combined holder/counter holder 101/103 pivotably on the gripper body 108. The counter holder 103 makes a pivot movement SB in solidarity with the holder 101.

In some embodiments as shown in FIG. 5E, a movably mounted ball or a movably mounted pressure element 105 can also be provided.

Enlarged perspective views of further embodiments of a gripper 102 are shown in FIGS. 6A and 6B. From bottom to top, the gripper 102 comprises the following:
a receptacle 109;
a gripper body 108 having a fixedly connected cantilever arm, which may be used as the counter holder 103;
the gripper body 108 having an inclined inner region 104;
the gripper body 108 having a receptacle opening 111 including a holder 101; the holder 101 having lateral surface 101.1;
a pivot axis SA, wherein the pivot movement of the holder 101 is indicated by the double arrow SB;
no movable elements 105 are arranged on the counter holder 103 in these embodiments.

FIG. 6A shows the holder 101 in an uppermost position and FIG. 6B shows the holder 101 in a lowermost position. It can be seen on the basis of these two figures how the angle of attack β can adapt because of the pivot movement SB of the holder 101.

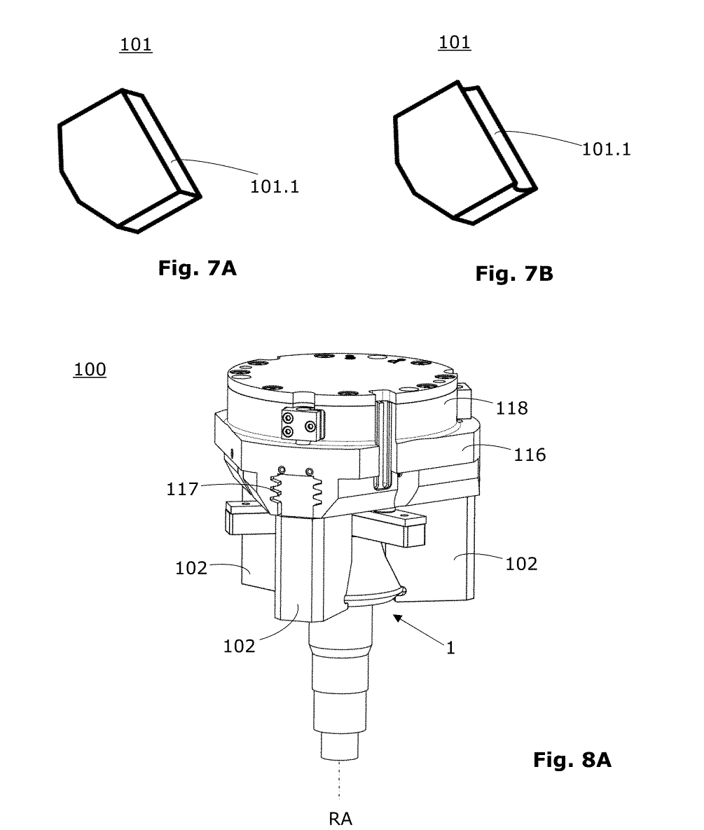

In certain of the illustrated embodiments, the holder 101 has a planar lateral surface 101.1. The planar lateral surface 101.1 may be tangential to a circumferential circle of the cone surface 1.1 of the bevel gear 1 after the infeed ZB. One such embodiment is shown in FIG. 7A.

Since the cone face 1.1 of the bevel gear 1 has a circular shape viewed in transverse section, the lateral surface 101.1 can have a curvature, such as schematically indicated in the embodiment of FIG. 7B. In some such embodiments, the curved lateral surface 101.1 can engage against the circumferential circle of the cone face 1.1 of the bevel gear 1 after the infeed.

A further embodiment of a device 100 is shown in FIG. 8A, having three grippers 102, which can hold a bevel gear 1 in a form-fitting manner. FIG. 8A shows a main body 116 and complementary guide structures 117 of a gripper 102. Accordingly, all three grippers 102 are guided linearly on the main body 116 and can be infed radially. A drive (not shown in FIG. 8A) can also be provided on the main body 116 to allow the three grippers 102 to be radially infed. The drive can, in some embodiments, be seated in the interior of a housing 118.

FIG. 8B shows a handling device 200, in the form of a robot arm, which comprises two devices 100 of FIG. 8A.

FIG. 9 shows a further embodiment of the device 100 having two grippers 102, which hold a bevel gear 1 in a form-fitting manner. A main body can also be provided (similarly to the main body 116 of FIGS. 8A and 8B), which can be provided with complementary guide structures and/or with a drive.

The applicant reserves the right to incorporate features from the description and the patent claims, which includes parts of sentences from the description and the claims, in a claim and, in particular, to make them the subject matter of a new patent claim.

Terms like substantially, preferably and the like and indications that may possibly be understood to be inexact are to be understood to mean that a deviation from the normal value is possible.

Unless stated otherwise, terms such as, for example, “comprises,” “has,” “includes,” and all forms thereof, are considered open-ended, so as not to preclude additional elements and/or features.

Also unless stated otherwise, terms such as, for example, “a” and “one” are considered open-ended, and do not mean “only a” and “only one”, respectively.

Also, unless stated otherwise, the phrase “a first” does not, by itself, require that there also be a “second.”

Also unless stated otherwise, terms such as, for example, “in response to” and “based on” mean “in response at least to” and “based at least on,” respectively, so as not to preclude being responsive to and/or based on, more than one thing.

While the above describes certain embodiments, those skilled in the art should understand that the foregoing description is not intended to limit the spirit or scope of the invention. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A device comprising at least two grippers configured to form-fittingly grip a bevel gear defining a cone face, a heel region, and an axis of rotation, wherein the at least two grippers are configured to be infed radially relative to the axis of rotation, each of the at least two grippers includes at least one inner region configured to interact with the cone face, a counter holder configured to interact with the heel region, and a holder located at the inner region having a changeable angle of attack, wherein the holder is movably mounted on its gripper so that its angle of attack adapts in relation to an inclination of the cone face of the bevel gear during said radial infeed of the at least two grippers.

2. The device according to claim 1, wherein the holder is configured as a rocker and is pivotably mounted on its gripper about a pivot axis.

3. The device according to claim 1, wherein the holder is mounted in a receptacle opening of its gripper.

4. The device according to claim 1, wherein the holder defines a lateral surface configured to exert a mechanical interaction with the cone face of the bevel gear.

5. The device according to claim 4, wherein the lateral surface defines either a planar surface configured to be located tangential to a circumferential circle defined by the cone face of the bevel gear after said radial infeed, or a curved surface configured to engage against said circumferential circle of the cone face of the bevel gear after said radial infeed.

6. The device according to claim 1, wherein the holder and the counter holder are configured as a rocker that is mounted pivotably on its gripper about a pivot axis, and wherein the holder is movable in coordination with the counter holder.

7. The device according to claim 1, wherein the counter holder is fixedly connected to its gripper.

8. The device according to claim 1, wherein the counter holder defines a cantilever or plate fixedly connected to its gripper.

9. The device according to claim 1, wherein the counter holder defines a cantilever or plate movably connected to its gripper.

10. The device according to claim 9, wherein the cantilever or plate is movable about a pivot axis.

11. The device according to claim 5, wherein the counter holder includes a ball or a pressure element.

12. The device according to claim 11, wherein the ball or the pressure element is movably mounted on the counter holder.

13. The device according to claim 1, wherein each of the at least two grippers includes a base movably mounted in a linear guide such that the gripper is linearly movable in the linear guide to radially infeed the gripper.

14. A handling device for use in or on a bevel gear cutting machine, wherein the handling device comprises:
at least one device including at least two grippers configured to form-fittingly grip a bevel gear defining a cone face, a heel region, and an axis of rotation, wherein the at least two grippers are configured to be infed radially relative to the axis of rotation, each of the at least two grippers includes at least one inner region configured to interact with the cone face, a counter holder configured to interact with the heel region, and a holder located at the inner region having a changeable angle of attack, wherein the holder is movably mounted on its gripper so that its angle of attack adapts in relation to an inclination of the cone face of the bevel gear during said radial infeed of the at least two grippers; and
a drive configured to radially infeed the at least two grippers relative to the axis of rotation of the bevel gear.
